(19) United States
(12) Patent Application Publication
(10) Pub. No.: US 2024/0030867 A1
(43) Pub. Date: Jan. 25, 2024

(54) SOLAR ENERGY OPTIMIZATION DEVICE, SOLAR ENERGY GENERATION SYSTEM AND POWER CONVERSION SYSTEM USING THE SAME

(71) Applicant: LITE-ON TECHNOLOGY CORPORATION, Taipei (TW)

(72) Inventor: Yi-Chao FAN, Taipei (TW)

(21) Appl. No.: 18/201,781

(22) Filed: May 25, 2023

Related U.S. Application Data
(60) Provisional application No. 63/390,316, filed on Jul. 19, 2022.

(30) Foreign Application Priority Data
Apr. 11, 2023 (TW) 112113464

(51) Int. Cl. H02S 50/00; H02S 40/36; H02J 3/38

(52) U.S. Cl. CPC H02S 50/00; H02S 40/36; H02J 3/38; H02J 2300/26

(57) ABSTRACT

A solar energy optimization device, a solar energy generation system and a power conversion system using the same are provided. The solar energy optimization device includes a plurality of conversion circuits and a plurality of control circuits. Each of conversion circuits is individually connected in series with a solar module. The conversion circuits and the solar modules are connected in series to a maximum power point tracking (MPPT) circuit. The MPPT circuit is configured to determine a photovoltaic current according to the solar modules. Each of the conversion circuits is used for converting a photovoltaic voltage of one of the solar modules into an output voltage. Each of the control circuits is used to adjust a conversion parameter of one of the conversion circuits to increase the output voltage thereof, so that an output power of each of the solar modules is optimized based on the photovoltaic current.

This application claims the benefit of US provisional application Ser. No. 63/390,316, filed Jul. 19, 2022, and Taiwan application Serial No. 112113464, filed Apr. 11, 2023, the disclosure of which is incorporated by reference herein in its entirety.

### TECHNICAL FIELD

The disclosure relates in general to an energy optimization device, an energy generation system and a conversion system using the same, and more particularly to a solar energy optimization device, a solar energy generation system and a power conversion system using the same.

### BACKGROUND

The solar board can convert solar energy into electricity, which is a clean and environmentally friendly way of generating electricity. In order to reduce environmental pollution, solar power generation technology has been widely used in various buildings, ships or vehicles.

Since the solar board might change its current-voltage characteristic curve at any time due to the influence of the environment, light and other factors. For better work efficiency, the Maximum Power Point Tracking (MPPT) technology is usually applied to obtain the maximum power point.

### SUMMARY

The disclosure is directed to a solar energy optimization device, a solar energy generation system and a power conversion system using the same. A control circuit is used to adjust a conversion parameter of a conversion circuit to increase an output voltage thereof, so that an output power of each solar module is individually optimized, and the working efficiency of the solar energy generation system is effectively improved.

According to one embodiment, a solar energy optimization device is provided. The solar energy optimization device includes a plurality of conversion circuits and a plurality of control circuits. Each of the conversion circuits is individually connected in series with a solar module. The conversion circuits and the solar modules are connected in series to a maximum power point tracking (MPPT) circuit. The MPPT circuit is configured to determine a photovoltaic current according to the solar modules. Each of the conversion circuits is used for converting a photovoltaic voltage of one of the solar modules into an output voltage. Each of the control circuits is used to adjust a conversion parameter of one of the conversion circuits to increase the output voltage thereof, so that an output power of each of the solar modules is optimized based on the photovoltaic current.

According to another embodiment, a solar energy generation system is provided. The solar energy generation system includes a plurality of solar modules, a plurality of conversion circuits, a maximum power point tracking (MPPT) circuit and a plurality of control circuits. The conversion circuits and the solar modules are alternately connected in series. The conversion circuits and the solar modules are connected in series to the MPPT circuit.

The MPPT circuit is configured to determine a photovoltaic current according to the solar modules. Each of the conversion circuits is used to convert a photovoltaic voltage of one of the solar modules into an output voltage. Each of the control circuits is used to adjust a conversion parameter of one of the conversion circuits to increase the output voltage thereof, so that an output power of each of the solar modules is optimized based on the photovoltaic current.

According to a power conversion system is provided. The power conversion system includes a first conversion device, a second conversion device and a maximum power point tracking (MPPT) circuit. The first conversion device includes a first input end, a conversion circuit, a first output end and a first control unit. The first input end is electrically coupled to a first power source. The conversion circuit is electrically coupled to the first input end, the first output end and the first control unit. The second conversion device includes a second input end, a conversion circuit, a second output end and a second control unit. The second input end is electrically coupled to a second power source. The conversion circuit is electrically coupled to the second input end, the second output end and the second control unit. The MPPT circuit is connected in series with the first output end and the second output end. The first control unit is configured to output a first control signal to adjust a first output voltage of the conversion circuit. The second control unit is configured to output a second control signal to adjust a second output voltage of the conversion circuit.

### BRIEF DESCRIPTION OF THE DRAWINGS

FIG. 1 shows a schematic diagram of a solar energy generation system according to an embodiment.

FIG. 2 illustrates a solar energy generation system according to an embodiment.

FIG. 3 shows a circuit diagram of the solar energy optimization

device and the solar module according to an embodiment.

FIG. 4 illustrates how the control circuit adjusts the conversion parameter.

FIG. 5 shows a circuit diagram of a solar energy optimization device and the solar module according to another embodiment.

FIG. 6 illustrates another way for the control circuit to adjust the conversion parameter.

FIG. 7 shows a solar energy generation system according to another embodiment.

FIG. 8 shows a power conversion system according to an embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

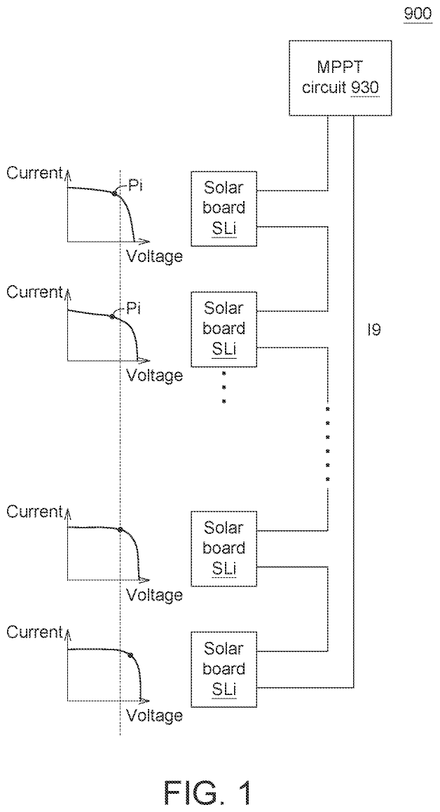

Please refer to FIG. 1, which shows a schematic diagram of a solar energy generation system 900 according to an embodiment. The solar energy generation system 900 includes a plurality of solar boards SLi and a Maximum Power Point Tracking (MPPT) circuit 930. The solar boards SLi are connected in series. The MPPT circuit 930 tracks the maximum power points of all of the solar boards SLi to obtain an overall maximum power point and determines a photovoltaic current 19.

Due to environmental differences and aging conditions, the power point corresponding to the photovoltaic current 19 of each of the solar boards SLi is not the maximum power point Pi of each of the solar boards SLi. This will make some of the solar boards SLi unable to achieve the best work efficiency.

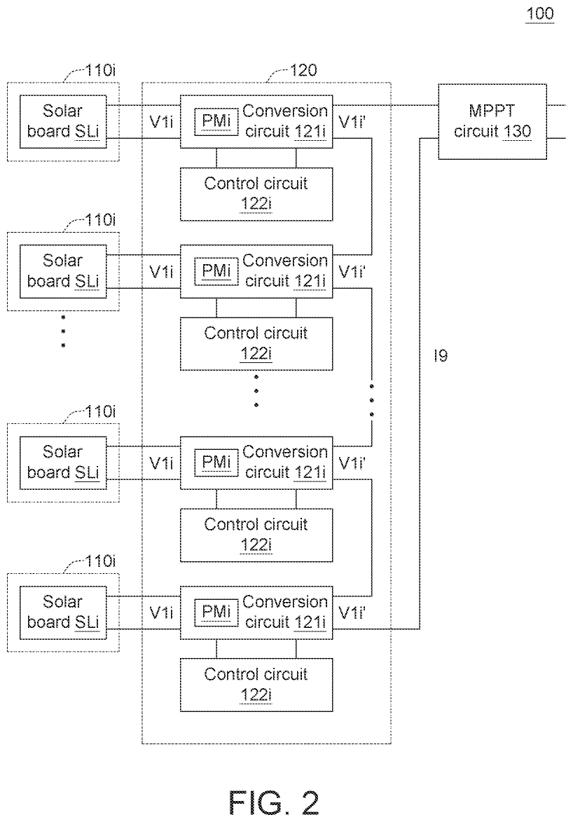

Please refer to FIG. 2, which illustrates a solar energy generation system 100 according to an embodiment. The solar energy generation system 100 includes a plurality of solar modules 110i, a solar energy optimization device 120 and a MPPT circuit 130. The solar modules 110i are connected in series. Each of the solar modules 110i includes, for example, a solar board or a plurality of solar boards. In the embodiment shown in FIG. 2, each of the solar modules 110i includes only one solar board SLi. The MPPT circuit 130 determines the overall maximum power point and the photovoltaic current 19 according to the solar modules 110i connected in series.

In this embodiment, since the solar modules 110i are connected in series, the current flowing through each of the solar modules 110i is the photovoltaic current 19.

The solar energy optimization device 120 includes a plurality of conversion circuits 121i and a plurality of control circuits 122i. Each of the conversion circuits 121i is individually connected in series with one of the solar modules 110i. The conversion circuits 121i and the solar modules 110i are alternately connected in series to the MPPT circuit 130.

Each of the conversion circuits 121i is used to convert one of the photovoltage voltages V1iof the solar modules 110i into an output voltage V1i′. Each of the conversion circuits 121i is, for example, a buck converter circuit, a boost converter circuit, or a buck—boost converter circuit/FLYBACK converter circuit. The conversion circuit 121i has a rapid shut down function, which can disconnect the connection of the solar module 110i when the system requires it.

Each of the control circuits 122i is electrically coupled to one of the conversion circuits 121i. Each of the control circuits 122i is used to adjust a conversion parameter PMi of one of the conversion circuits 121i. The conversion parameter PMi is, for example, a duty cycle or a frequency. When the conversion parameter PMi of one of the conversion circuits 121i is adjusted, the output voltage V1i′ output by this conversion circuit 121i will also be adjusted. Therefore, the adjustment of each of the conversion parameters PMi can be used to increase the output voltage V1i′ thereof, so that the output power of each of the solar modules 110i is optimized based on the same photovoltaic current 19.

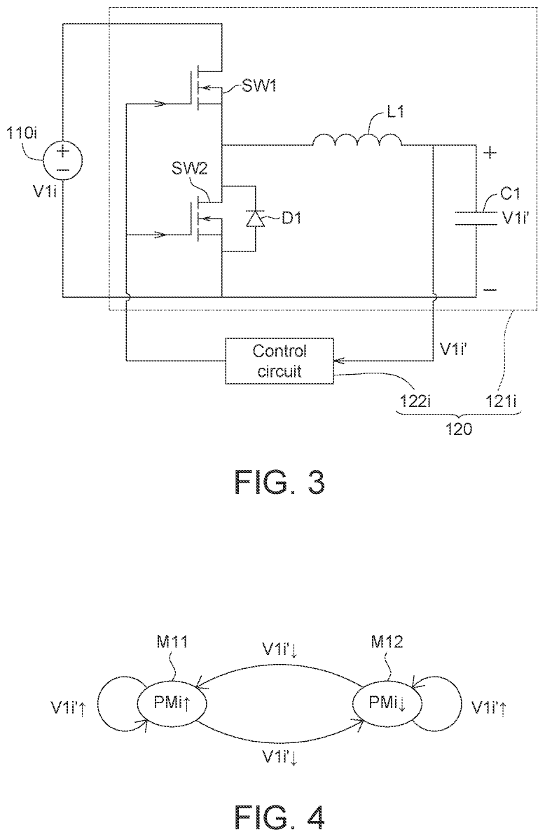

Please refer to FIG. 3, which shows a circuit diagram of the solar energy optimization device 120 and the solar module 110i according to an embodiment. The conversion circuit 121i of one of the solar energy optimization devices 120 includes, for example, a first switch element SW1, a second switch element SW2, an inductor L1, a capacitorC1 and a diode D1. The control circuit 122i is electrically coupled to the output terminal of the inductor L1, so that the output voltage V1i′ is fed back to the control circuit 122i , and the change of the output voltage V1 i′ is detected by the control circuit 122i . The control circuit 122i is further electrically coupled to the first switch element SW1 and the second switch element SW2, so as to control the first switch element SW1 and the second switch element SW2 according to the change of the output voltage V1i′, and then adjust the conversion parameter PMi.

Please refer to FIG. 4, which illustrates how the control circuit 122i adjusts the conversion parameter PMi. In a first control mode M11, the control circuit 122i adjusts the conversion parameter PMi in a first direction. The first direction is, for example, to increase the value of the conversion parameter PMi. In the second control mode M12, the control circuit 122i adjusts the conversion parameter PMi in a second direction. The second direction is, for example, to reduce the value of the conversion parameter PMi.

After the first control mode M11 is executed, if the output voltage V1i′ is pulled up, the control circuit 122i is kept at the first control mode M11 (The control circuit 122i continues to adjust the conversion parameter PMi with the same first direction), so that the output voltage V1i′ can continue to be pulled up. After the first control mode M11 is executed, if the output voltage V1i′ is pulled down, the control circuit 122i is switched to the second control mode M12 (The control circuit 122i adjusts the conversion parameter PMi in the second direction opposite to the first direction), so that the output voltage V1i′ can be pulled up.

After the second control mode M12 is executed, if the output voltage V1i′ is pulled up, the control circuit 122i is kept at the second control mode

(The control circuit 122i continues to adjust the conversion parameter PMi with the same second direction), so that the output voltage V1 i′ can continue to be pulled up. After the second control mode M12 is executed, if the output voltage V1i′ is pulled down, the control circuit 122i is switched to the first control mode M11 (The control circuit 122i adjusts the conversion parameter PMi in the first direction opposite to the second direction), so that the output voltage V1i′ can be pulled up.

After optimization, the output voltages V1i′ of the solar modules 110i are not exactly identical. After each of the output voltages V1i′ is pulled up, the output power of each of the solar modules 110i is also increased, so that the overall output power can be significantly optimized.

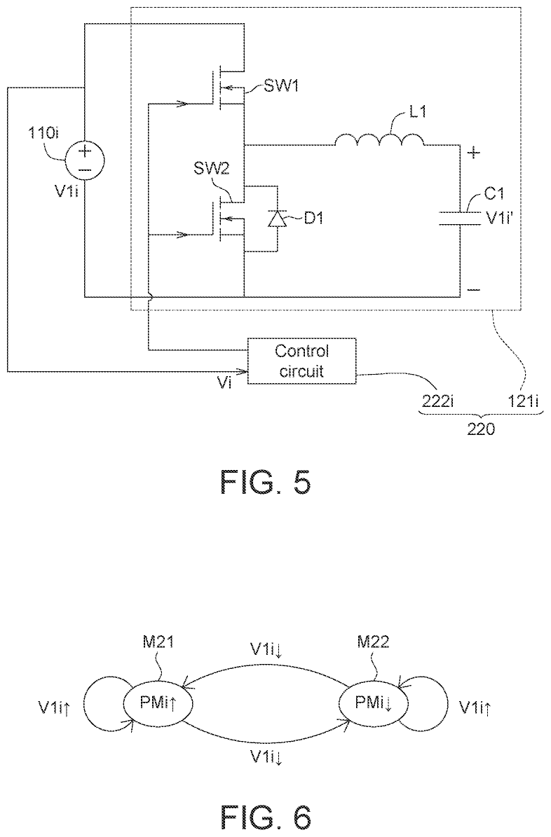

In another embodiment, the control circuit 122i can also detect the photovoltaic voltage V1i, and adjust the conversion parameter PMi accordingly. Please refer to FIG. 5, which shows a circuit diagram of a solar energy optimization device 220 and the solar module 110i according to another embodiment. The control circuit 222i of the solar energy optimization device 220 is electrically coupled to the output terminal of the solar module 110i, so that the photovoltaic voltage V1iis fed back to the control circuit 122i , and the change of the photovoltaic voltage V1iis detected by the control circuit 122i. The control circuit 222i is further connected to the first switch element SW1 and the second switch element SW2, so as to control the first switch element SW1 and the second switch element SW2 according to the change of the photovoltaic voltage V1i, and then adjust the conversion parameter PMi.

Please refer to FIG. 6, which illustrates another way for the control circuit 222i to adjust the conversion parameter PMi. In the first control mode M21, the control circuit 222i adjusts the conversion parameter PMi in a first direction. The first direction is, for example, to increase the value of the conversion parameter PMi. In the second control mode M22, the control circuit 222i adjusts the conversion parameter PMi in a second direction. The second direction is, for example, to reduce the value of the conversion parameter PMi.

After the first control mode M21 is executed, if the photovoltaic voltage V1iis pulled up, the control circuit 222i is kept at the first control mode M11 (The control circuit 222i continues to adjust the conversion parameter PMi with the same first direction), so that the photovoltaic voltage V1ican continue to be pulled up, and then the output voltage V1i′ can be pulled up. After the first control mode M21 is executed, if the photovoltaic voltage V1iis pulled down, then the control circuit 222i is switched to the second control mode M22 (The control circuit 222i adjusts the conversion parameter PMi in the second direction opposite to the first direction), so that the photovoltaic voltage V1ican be pulled up, and then the output voltage V1 i′ can be pulled up.

After the second control mode M22 is executed, if the photovoltaic voltage V1iis pulled up, the control circuit 222i is kept at the second control mode M22 (The control circuit 222i continues to adjust the conversion parameter PMi with the same second direction), so that the photovoltaic voltage V1ican continue to be pulled up, and then the output voltage V1 i′ can be pulled up. After the second control mode M22 is executed, if the photovoltaic voltage V1iis pulled down, then the control circuit 222i is switched to the first control mode M21 (The control circuit 222i adjusts the conversion parameter PMi in the first direction opposite to the second direction), so that the photovoltaic voltage V1ican be pulled up, and then the output voltage V1i′ can be pulled up.

After optimization, the output voltages V1i′ of the solar modules 110i are not exactly identical. After each of the output voltages V1i′ is pulled up, the output power of each of the solar modules 110i is also increased, so that the overall output power can be significantly optimized.

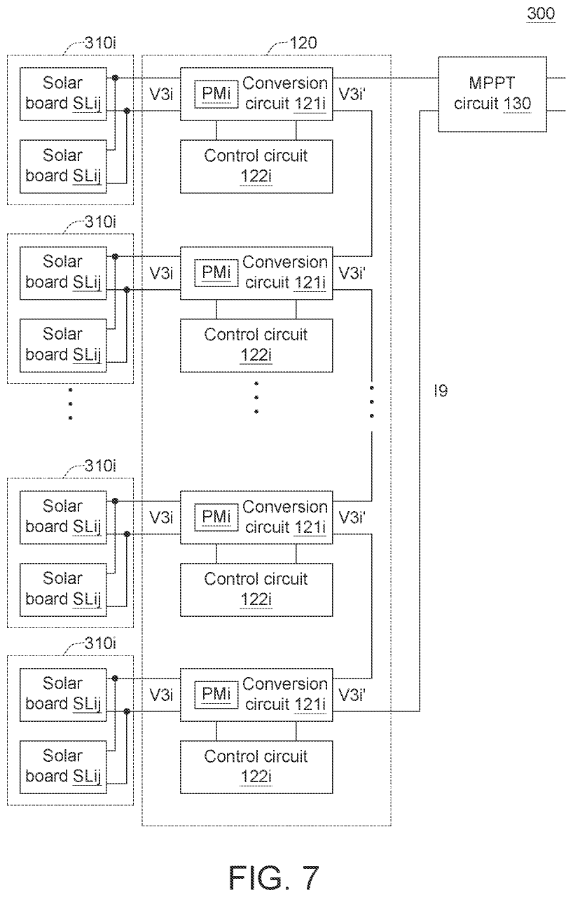

Moreover, please refer to FIG. 7, which shows a solar energy generation system 300 according to another embodiment. In the embodiment shown in FIG. 7, each of the solar modules 310i includes a plurality of solar boards SLij. These solar boards SLij are connected in parallel to form one of the solar modules 310i. Each of the conversion circuits 121i is used to convert one of the photovoltage voltages V3i of the solar modules 310i into an output voltage V3i′. Each of the control circuits 122i can adjust the conversion parameter PMi of one of the conversion circuits 121i to increase the output voltage V3i′ outputted by that conversion circuit 121i. Therefore, the adjustment of each of the conversion parameters PMi can be used to increase each of the output voltages V3i′, so that the output power of each of the solar modules 310i is optimized based on the same photovoltaic current 19. In this embodiment, the optimization target can be several solar boards SLij connected in parallel, instead of a single solar board SLij.

According to the above various embodiments, each of the control circuits 122i, 222i is used to modulate one of the conversion parameters PMi of the conversion circuits 121i to increase the output voltage V1i′ thereof, so that the output power of each of the solar modules 110i, 310i is individually optimized, and the working efficiency of the solar energy generation system 100, 300 is effectively improved.

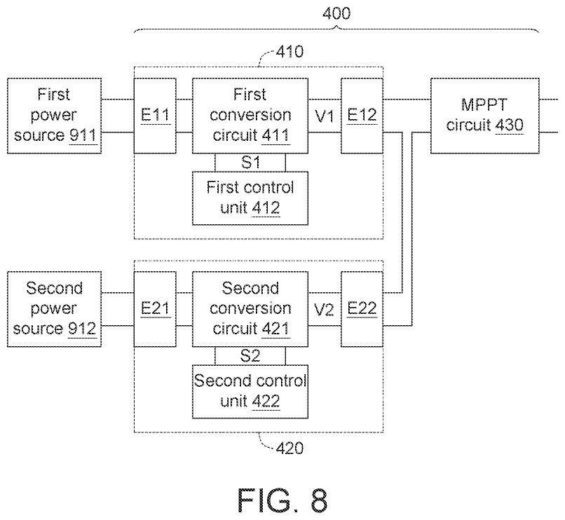

Furthermore, please refer to FIG. 8, which shows a power conversion system 400 according to an embodiment. The technology disclosed in this disclosure can also be implemented in the power conversion system 400. As shown in FIG. 8, the power conversion system 400 includes a first conversion device 410, a second conversion device 420 and a MPPT circuit 430. The first conversion device 410 includes a first input end Ell, a first conversion circuit 411, a first output end E12 and a first control unit 412. The first conversion circuit 411 is, for example, the conversion circuit 121i mentioned above. The first control unit 412 is, for example, the control circuit 122i, 222i mentioned above. The first control unit 412 is, for example, the control circuit 122i mentioned above. The first input end E11 is electrically coupled to a first power source 911. The first power source 911 is, for example, the solar module 110i, 310i mentioned above. The first conversion circuit 411 is electrically connected to the first input end El 1 , the first output end E12 and the first control unit 412.

The second conversion device 420 includes a second input end E21, a second conversion circuit 421, a second output end E22 and a second control unit 422. The second conversion circuit 421 is, for example, the conversion circuit 121i mentioned above. The second control unit 422 is, for example, the control circuit 122i, 222i mentioned above. The second input end E21 is electrically coupled to a second power source 912. The second power source 912 is, for example, the solar module 110i, 310i. The second conversion circuit 421 is electrically coupled to the second input end E21, the second output end E22 and the second control unit 422.

The MPPT circuit 430 is, for example, the MPPT circuit 130 mentioned above. The MPPT circuit 430 is connected in series with the first output end El 2 and the second output end E22.

The first control unit 412 outputs a first control signal S1 to adjust a first output voltage V1 of the first conversion circuit 411. The first control signal S1 is, for example, a Pulse Width Modulation (PWM) signal. The first control unit 412 adjusts the first control signal S1 to change the first output voltage Vl. For example, the first control unit 412 can adjust the duty cycle or frequency of the first control signal S1. The adjustment range of the duty cycle or frequency of the first control signal S1 is, for example, 1% or a preset value. In one embodiment, the adjustment range of the duty cycle or frequency of the first control signal S1 can be dynamically adjusted instead of a fixed value.

The first control unit 412 can measure the change of the first output voltage V1. When the first output voltage V1 is decreased compared with the voltage value measured last time, the first control unit 412 can reversely adjust the duty cycle or frequency of the first control signal S1.

For example, when the voltage value of the first output voltage V1 is increased in response to the increase of the duty cycle or frequency of the first control signal S1, the first control unit 411 continuously increases the duty cycle or frequency of the first control signal S1. When the first output voltage V1 is decreased in response to the increase of the duty cycle or frequency of the first control signal S1, the first control unit 411 reduces the duty cycle or frequency of the first control signal S1.

The second control unit 422 outputs a second control signal S2 to adjust a second output voltage V2 of the second conversion circuit 421. The second control signal S2 is, for example, a Pulse Width Modulation (PWM) signal. The second control unit 422 adjusts the second control signal S2 to change the second output voltage V2. For example, the second control unit 422 can adjust the duty cycle or frequency of the second control signal S2. The adjustment range of the duty cycle or frequency of the second control signal S2 is, for example, 1% or a preset value. In one embodiment, the adjustment range of the duty cycle or frequency of the second control signal S2 can be dynamically adjusted instead of a fixed value.

The second control unit 422 can measure the change of the second output voltage V2. When the second output voltage V2 is decreased compared with the voltage value measured last time, the second control unit 422 can reversely adjust the duty cycle or frequency of the second control signal S2.

For example, when the voltage value of the second output voltage V2 is increased in response to the increase of the duty cycle or frequency of the second control signal S2, the second control unit 422 continuously increases the duty cycle or frequency of the second control signal S2. When the second output voltage V2 is decreased in response to the increase of the duty cycle or frequency of the second control signal S2, the second control unit 422 reduces the duty cycle or frequency of the second control signal S2.

In an embodiment, the first output voltage V1 mentioned above may not be equal to the second output voltage V2 mentioned above.

According to the above embodiment, the first control unit 412 and the second control unit 422 are used to adjust the first control signal S1 and the second control signal S2 to increase the first output voltage V1 and the second output voltage V2, so that the output powers of the first power source 911 and the second power source 912 can be individually optimized to effectively improve the working efficiency of the power conversion system 400. In other words, under the condition that the MPPT circuit 430 determines a photovoltaic current, by adjusting the first control signal S1 and the second control signal S2, the first output voltage V1 and the second output voltage V2 become local maximums respectively, so that the sum of the first output voltage V1 and the second output voltage V2 is maximized to increase power.

It will be apparent to those skilled in the art that various modifications and variations can be made to the disclosed embodiments. It is intend Ed that the specification and examples be considered as exemplary only, with a true scope of the disclosure being indicated by the following claims and their equivalents.

What is claimed is:

1. A solar energy optimization device, comprising:
a plurality of conversion circuits, wherein each of the conversion circuits is individually connected in series with a solar module, the conversion circuits and the solar modules are connected in series to a maximum power point tracking (MPPT) circuit, the MPPT circuit is configured to determine a photovoltaic current according to the solar modules, and each of the conversion circuits is used for converting a photovoltaic voltage of one of the solar modules into an output voltage; and
a plurality of control circuits, wherein each of the control circuits is used to adjust a conversion parameter of one of the conversion circuits to increase the output voltage thereof, so that an output power of each of the solar modules is optimized based on the photovoltaic current.

2. The solar energy optimization device according to claim 1, wherein
each of the control circuits is configured to adjust one of the conversion parameters in a first direction;
if one of the photovoltaic voltages or one of the output voltages is pulled up, the control circuit corresponding thereto continues to adjust the conversion parameter in the first direction;
if one of the photovoltaic voltages or one of the output voltages is pulled down, the control circuit corresponding thereto adjusts the conversion parameter in a second direction which is opposite to the first direction.

3. The solar energy optimization device according to claim 1, wherein the output voltages of the solar modules which are optimized are not exactly identical.

4. The solar energy optimization device according to claim 1, wherein one of the solar modules includes a plurality of solar boards connected in parallel.

5. The solar energy optimization device according to claim 1, wherein one of the solar modules includes only one solar board.

6. The solar energy optimization device according to claim 1, wherein each of the conversion parameters is a duty cycle or a frequency.

7. The solar energy optimization device according to claim 1, wherein each of the control circuits is connected to one of the output terminals of the conversion circuits, so that the output voltages are fed back to the control circuits respectively.

8. The solar energy optimization device according to claim 1, wherein each of the control circuits is connected to one of the output terminals of the solar modules, so that the photovoltaic voltages are fed back to the control circuits respectively.

9. The solar energy optimization device according to claim 1, wherein each of the conversion circuits includes a first switch element and a second switch element, and each of the control circuits is connected to one of the first switch elements and one of the second switch elements, so that the conversion circuits are controlled by the control circuits respectively.

10. A solar energy generation system, comprising:
a plurality of solar modules;
a plurality of conversion circuits, wherein the conversion circuits and the solar modules are alternately connected in series;
a maximum power point tracking (MPPT) circuit, wherein the conversion circuits and the solar modules are connected in series to the MPPT circuit, the MPPT circuit is configured to determine a photovoltaic current according to the solar modules, and each of the conversion circuits is used to convert a photovoltaic voltage of one of the solar modules into an output voltage; and
a plurality of control circuits, wherein each of the control circuits is used to adjust a conversion parameter of one of the conversion circuits to increase the output voltage thereof, so that an output power of each of the solar modules is optimized based on the photovoltaic current.

11. A power conversion system, comprising:
a first conversion device, including a first input end, a conversion circuit, a first output end and a first control unit, wherein the first input end is electrically coupled to a first power source, and the conversion circuit is electrically coupled to the first input end, the first output end and the first control unit;
a second conversion device, including a second input end, a conversion circuit, a second output end and a second control unit, wherein the second input end is electrically coupled to a second power source, and the conversion circuit is electrically coupled to the second input end, the second output end and the second control unit; and
a maximum power point tracking (MPPT) circuit, connected in series with the first output end and the second output end,
wherein the first control unit is configured to output a first control signal to adjust a first output voltage of the conversion circuit, and the second control unit is configured to output a second control signal to adjust a second output voltage of the conversion circuit.

12. The power conversion system according to claim 11, wherein the first output voltage is not equal to the second output voltage.

13. The power conversion system according to claim 11, wherein the first control signal and the second control signal are Pulse Width Modulation (PWM) signals.

14. The power conversion system according to claim 11, wherein the first control unit is configured to adjust the first control signal to change the first output voltage, and the second control unit is configured to adjust the second control signal to change the second output voltage.

15. The power conversion system according to claim 14, wherein the first control unit is configured to adjust a duty cycle or a frequency of the first control signal, and the second control unit is configured to adjust a duty cycle or a frequency of the second control signal.

16. The power conversion system according to claim 15, wherein if the first output voltage is increased in response to an increasing of the duty cycle or the frequency of the first control signal, the first control unit continues to increase the duty cycle or the frequency of the first control signal; if the first output voltage is decreased in response to the increasing of the duty cycle or the frequency of the first control signal, the first control unit decreases the duty cycle or the frequency of the first control signal.

17. The power conversion system according to claim 15, wherein if the second output voltage is increased in response to an increasing of the duty cycle or the frequency of the second control signal, the second control unit continues to increase the duty cycle or the frequency of the second control signal; if the second output voltage is decreased in response to the increasing of the duty cycle or the frequency of the second control signal, the second control unit decreases the duty cycle or the frequency of the second control signal.
